(19) United States
(12) Patent Application Publication
(10) Pub. No.: US 2019/0356652 A1
(43) Pub. Date: Nov. 21, 2019

(54) Secure Interoperable Set Top Box Through Reverse OTP

(71) Applicant: Centre For Development Of Telematics, New Delhi (IN)

(72) Inventors: Vipin TYAGI, New Delhi (IN); Sridharan B, Bengaluru (IN); Pallab DUTTA, Bengaluru (IN); Priyanka JAIN, Bengaluru (IN); Maheshkumar Yadavrao GADGE, Bengaluru (IN); Giri Babu E, Bengaluru (IN); Nagaraj N. NAYAK, Bengaluru (IN)

(73) Assignee: Centre For Development Of Telematics, New Delhi (IN)

(21) Appl. No.: 15/980,678

(22) Filed: May 15, 2018

(51) Int. Cl. H04L 29/06; H04N 21/258

(52) U.S. Cl. CPC H04L 63/0838; H04N 21/25816; H04L 63/0428

(57) ABSTRACT

Disclosed is a set top box (STB) configured to work with a smart card (SC) wherein the STB is authenticated by an operator who provides the smart card to a user using a One Time Password (OTP). The OTP is generated by the SC and sent via the STB to the operator through a user mobile device operatively coupled with the STB. The operator verifies the sender based upon registered mobile number of the sender, decrypts the received OTP and uses the decrypted OTP to transmit STB specific control messages to the STB and facilitate registration of the SC. Thereafter the STB can receive and decrypt channel data being transmitted by the operator. The SC, STB and the user mobile device have secure communication amongst each other after authentication of each other. Data sent between the user mobile device and the operator is encrypted.

### FIELD OF DISCLOSURE

The present disclosures relate to the field of television signals delivered via broadcast networks. More particularly, the present disclosures relates to a system and method for authenticating a set top box (STB) in a broadcast network.

### BACKGROUND OF THE DISCLOSURE

The background description includes information that may be useful in understanding the present invention. It is not an admission that any of the information provided herein is prior art or relevant to the presently claimed invention, or that any publication specifically or implicitly referenced is prior art.

Background description includes information that may be useful in understanding the present invention. It is not an admission that any of the information provided herein is prior art or relevant to the presently claimed invention, or that any publication specifically or implicitly referenced is prior art.

Set top boxes (STBs) are well known and have become most popular means of delivering secure content (usually content for which a user/subscriber has paid, hence also known as pay-TV content) that is broadcast using Cable TV and Direct to Home (DTH) to subscribers worldwide by different service providers using their broadcast networks. While other modes such as Internet Protocol TV, Head-end in the Sky (HITS) are also being developed, overall they have a minuscule subscriber base compared to Cable TV and Direct to Home systems.

In DTH services a Customer Premises Equipment (CPE) that includes a set top box, a Dish Antenna along with LNBC (low noise block converter) and RF cable is required to be connected to a TV set, while in Cable TV services, the CPE comprises of STB only. Further, in many cases, the smart cards are also used along with the STBs.

Service providers ensure TV programs being transmitted by them on their broadcast networks can be received only by people duly authorized (for example, people who have paid to receive signal of a TV channel, interchangeably termed as paid subscribers of that TV channel) by scrambling their signals with control words that are decrypted by a smart card to enable unscrambling of the signals by the STB.

Presently the STB of a particular service operator installed at the premises of a subscriber cannot be used by the subscriber for reception of signals of other operators. Although all STBs used for pay-TV services perform essentially same functions they remain distinct from each other, as if they were different equipment. In such a scenario, if a subscriber wants to change his operator (broadcast network) for any reason, he is forced to buy STB of service operator he is changing to. This limitation is referred to as non-interoperability of STB. STB is non-interoperable and is tied to specific service operator due to various technical, commercial and market driven reasons.

As is obvious, this non-interoperability of STBs has major commercial issues for all concerned. At the customer end, it can lead to high dissatisfaction level in case he is not satisfied with his existing operator since he cannot change the operator without discarding his existing STB. In extreme cases, customers may decide to discard the STB leading to a huge waste wherein a large number of STBs remain idle, mainly because of this vexing issue of non-interoperability of STBs. Associated is the problem of large e-waste generation. Besides, non-interoperability of STBs between different service providers doesn't encourage competition and so, hinders technological innovation, improvement in service quality and overall sector growth.

While efforts are underway to bring interoperability of STBs as is essential for an interoperable STB framework, content security remains a foremost concern. Any service provider wants content being sent out from its headend (headend being a control centre in a television system where various content signals are brought together and monitored before being introduced into broadcast network) to be enjoyed only by its paid/authorized subscribers. However, since broadcast system is a one way system (transmission is always from headend to STB), any unauthorized reception of content is very difficult to detect on headend side by an operator.

Hence there is a need in the art for a system that prevents any unauthorized reception of content in an interoperable STB framework.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities or dimensions of items, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

### OBJECTS OF THE DISCLOSURE

Some of the objects of the present disclosure, which at least one embodiment herein satisfies are as listed herein below.

It is an object of the present disclosure to provide for an interoperable set top box (STB) framework wherein an STB can be used with different operators thereby encouraging competition and technical innovation, and reducing e-waste.

It is an object of the present disclosure to provide for an STB that need not be discarded when its operator is changed.

It is an object of the present disclosure to provide for an STB that prevents any unauthorized reception of content in an interoperable STB framework.

### SUMMARY

The present disclosures relates to a system and method for authenticating a set top box (STB) in a broadcast network. In particular, it relates to a STB that uses a reverse One Time Password procedure for its authentication.

In an aspect, present disclosure elaborates upon a set top box (STB) that can be configured to receive (say by physical insertion) an unregistered smart card (SC) that is issued by an operator, said STB being further configured to: enable the unregistered SC to generate and encrypt a one-time-password (OTP); and transmit the encrypted OTP to the operator through a user mobile device that is operatively coupled with the STB, wherein the operator can decrypt the received OTP, and can use the decrypted OTP so as to transmit STB specific control messages to the STB and facilitate registration of the SC.

In another aspect, the SC can be configured to store any or a combination of a unique SC ID, user key, SC certificate, and a public key part of public-private key pair, and wherein the SC can encrypt the OTP using the user key.

In yet another aspect, the STB can be bought from a manufacturer that can be different from the operator, the STB being associated with a unique STB ID.

In an aspect, the user mobile device can be configured with an application provided by the operator, the application being coupled with registered mobile number of the user mobile device.

In another aspect, the application can generate a key pair and can receive a certificate issued for the key pair from the operator, using which, a session can be initiated between the operator and the application configured in the user mobile device.

In yet another aspect, the operator can verify subscriber corresponding to the user mobile device based on the registered mobile number.

In an aspect, upon receipt of the SC in the STB, the SC and the STB can authenticate each other so as to establish a secure communication channel between them using a shared session key.

In another aspect, a second secure communication channel can be established between the user mobile device and the STB using a second shared session key.

In yet another aspect, at the operator, the decrypted OTP can be processed along with a user key assigned to subscriber of the SC so as to generate a temporary key (TK) that can be also generated by the SC configured in the STB. In an aspect, the operator can be configured to generate a random periodic key (PK) that can be used to encrypt subscriber-specific data after the SC is registered, wherein the PK can be encrypted with TK, and subsequently with public key of a public-private key pair of the STB, such that upon receipt of the encrypted information by the STB, the STB can decrypt the encrypted information with its private key of the key pair, post which the SC can decrypt the encrypted information with its TK so as to obtain PK based on which the SC can be registered.

In another aspect, the STB and the SC can, as part of registration process or afterwards, generate separate random pairing-ids, and share them with each other for future confirmation on whether they are paired with each other.

In another aspect, the present disclosure elaborates upon a smart card (SC) that can be issued by an operator, and can be configured to be received in a set top box (STB), wherein the SC can be initially unregistered and, as part of its registration process: can generate and encrypt a one-time-password (OTP); and using the STB, can transmit the encrypted OTP to the operator through a user mobile device that can be operatively coupled with the STB, wherein the operator can decrypt the received OTP, and can use the decrypted OTP so as to transmit STB specific control messages to the STB and facilitate registration of the SC.

In another aspect of the SC, the SC can be configured to store any or a combination of a unique SC ID, user key, SC certificate, and a public key part of public-private key pair, and wherein the SC can encrypt the OTP using the user key.

In yet another aspect of the SC, upon receipt of the SC in the STB, the SC and the STB can authenticate each other so as to establish a secure communication channel between them using a shared session key.

In an aspect of the SC, at the operator, the decrypted OTP can be processed along with a user key assigned to subscriber of the SC so as to generate a temporary key (TK), which can be also generated by the SC configured in the STB.

In another aspect of the SC, the operator can be configured to generate a random periodic key (PK) that can be used to encrypt subscriber-specific data after the SC is registered, wherein the PK can be encrypted with TK and subsequently with public key of a public-private key pair of the STB, such that upon receipt of the encrypted information, the STB can decrypt the encrypted information with its private key of the key pair, post which the SC can decrypt the encrypted information with its TK so as to obtain PK based on which the SC can be registered.

In yet another aspect of the SC, the STB and the SC can generate separate random pairing-ids and can share them with each other for future confirmation of whether they are paired with each other.

In an aspect present disclosure elaborates upon a method of registering a smart card (SC) with a set top box (STB) configured to receive the SC, the method including the steps of: enabling, at the SC, generation and encryption of a one-time-password (OTP); and transmitting, from the STB, to the operator, the encrypted OTP through a user mobile device that is operatively coupled with the STB, wherein the operator can decrypt the received OTP, and can use the decrypted OTP so as to transmit STB specific control messages to the STB and facilitate registration of the SC.

In another aspect, the method can further include the steps of: processing, at the operator, the decrypted OTP along with a user key assigned to subscriber of the SC so as to generate a temporary key (TK); generating, at the SC, the TK using the user key and the OTP; generating, at the operator, a random periodic key (PK) that is used to encrypt subscriber-specific data after the SC is registered, wherein the PK is subsequently encrypted with TK and subsequently with public key of a public-private key pair of the STB to generate aggregate encrypted information; transmitting, from the operator, to the STB, the aggregate encrypted information; upon receipt of the aggregate encrypted information, decrypting, at the STB, the encrypted information with its private key of the key pair; decrypting, at the SC, the remaining encrypted information with its TK so as to obtain PK, based on which the SC can be registered.

In yet another aspect the method can further include the step of generating separate random pairing-ids at the STB and the SC and share them with each other for future confirmation of whether they are paired with each other.

In an aspect, the method can further include the step of, upon receipt of the SC in the STB, enabling the SC and the STB to authenticate each other so as to establish a secure communication channel between them using a shared session key.

Various objects, features, aspects and advantages of the present disclosure will become more apparent from the following detailed description of preferred embodiments, along with the accompanying drawing figures in which like numerals represent like features.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure, and wherein:

FIG. 1A illustrates an exemplary architecture of proposed invention, in accordance with an embodiment of the present disclosure.

FIG. 1B illustrates another exemplary architecture of the proposed invention in accordance with an exemplary embodiment of the present disclosure.

FIG. 2 elaborates via a sequence chart working of the proposed invention, in accordance with an exemplary embodiment of the present disclosure.

FIG. 3 illustrates a method of working of the proposed invention in accordance with an exemplary embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

Embodiments of the present invention may be provided as a computer program product including a mobile application. These may include a machine-readable storage medium tangibly embodying thereon instructions, which may be used to program a computer (or other electronic devices) toperform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition persons in the pertinent art have given that term as reflected in printed publications and issued patents at the time of filing.

The present disclosures relates to a system and method for authenticating a set top box (STB) in a broadcast network. In particular, it relates to a STB that uses a reverse One Time Password procedure for its authentication.

In an aspect, present disclosure elaborates upon a set top box (STB) that can be configured to receive an unregistered smart card (SC) that is issued by an operator, the STB being further configured to: enable the unregistered SC to generate and encrypt a one-time-password (OTP); and transmit the encrypted OTP to the operator through a user mobile device that is operatively coupled with the STB, wherein the operator can decrypt the received OTP, and can use the decrypted OTP so as to transmit STB specific control messages to the STB and facilitate registration of the SC.

In another aspect, the SC can be configured to store any or a combination of a unique SC ID, user key, SC certificate, and a public key part of public-private key pair, and wherein the SC can encrypt the OTP using the user key.

In yet another aspect, the STB can be bought from a manufacturer that can be different from the operator, the STB being associated with a unique STB ID.

In an aspect, the user mobile device can be configured with an application provided by the operator, the application being coupled with registered mobile number of the user mobile device.

In another aspect, the application can generate a key pair and can receive a certificate issued for the key pair from the operator, using which, a session can be initiated between the operator and the application configured in the user mobile device.

In yet another aspect, the operator can verify subscriber corresponding to the user mobile device based on the registered mobile number.

In an aspect, upon receipt of the SC in the STB, the SC and the STB can authenticate each other so as to establish a secure communication channel between them using a shared session key.

In another aspect, a second secure communication channel can be established between the user mobile device and the STB using a second shared session key.

In yet another aspect, at the operator the decrypted OTP can be processed along with a user key assigned to subscriber of the SC so as to generate a temporary key (TK), which can be also generated by the SC configured in the STB.

In an aspect, the operator can be configured to generate a random periodic key (PK) that can be used to encrypt subscriber-specific data after the SC is registered, wherein the PK can be encrypted with TK and subsequently with public key of a public-private key pair of the STB, such that upon receipt of the encrypted information, the STB can decrypt the encrypted information with its private key of the key pair, post which the SC can decrypt the encrypted information with its TK so as to obtain PK based on which the SC can be registered.

In another aspect, the STB and the SC can generate separate random pairing-ids and can share them with each other for future confirmation of whether they are paired with each other.

In an aspect present disclosure elaborates upon a smart card (SC) that can be issued by an operator and can be configured to be received in a set top box (STB), wherein the SC can be initially unregistered and, as part of its registration process: can generate and encrypt a one-time-password (OTP); and using the STB, can transmit the encrypted OTP to the operator through a user mobile device that can be operatively coupled with the STB, wherein the operator can decrypt the received OTP, and can use the decrypted OTP so as to transmit STB specific control messages to the STB and facilitate registration of the SC.

In another aspect of the SC, the SC can be configured to store any or a combination of a unique SC ID, user key, SC certificate, and a public key part of public-private key pair, and wherein the SC can encrypt the OTP using the user key.

In yet another aspect of the SC, upon receipt of the SC in the STB, the SC and the STB can authenticate each other so as to establish a secure communication channel between them using a shared session key.

In an aspect of the SC, at the operator, the decrypted OTP can be processed along with a user key assigned to subscriber of the SC so as to generate a temporary key (TK), which can be also generated by the SC configured in the STB.

In another aspect of the SC, the operator can be configured to generate a random periodic key (PK) that can be used to encrypt subscriber-specific data after the SC is registered, wherein the PK can be encrypted with TK and subsequently with public key of a public-private key pair of the STB, such that upon receipt of the encrypted information, the STB can decrypt the encrypted information with its private key of the key pair, post which the SC can decrypt the encrypted information with its TK so as to obtain PK based on which the SC can be registered.

In yet another aspect of the SC, the STB and the SC can generate separate random pairing-ids and can share them with each other for future confirmation of whether they are paired with each other.

In an aspect present disclosure elaborates upon a method of registering a smart card (SC) with a set top box (STB) configured to receive the SC, the method including the steps of: enabling, at the SC, generation and encryption of a one-time-password (OTP); and transmitting, from the STB, to the operator, the encrypted OTP through a user mobile device that is operatively coupled with the STB, wherein the operator can decrypt the received OTP, and can use the decrypted OTP so as to transmit STB specific control messages to the STB and facilitate registration of the SC.

In another aspect, the method can further include the steps of: processing, at the operator, the decrypted OTP along with a user key assigned to subscriber of the SC so as to generate a temporary key (TK); generating, at the SC, the TK using the user key and the OTP; generating, at the operator, a random periodic key (PK) that is used to encrypt subscriber-specific data after the SC is registered, wherein the PK is subsequently encrypted with TK and subsequently with public key of a public-private key pair of the STB to generate aggregate encrypted information; transmitting, from the operator, to the STB, the aggregate encrypted information; upon receipt of the aggregate encrypted information, decrypting, at the STB, the encrypted information with its private key of the key pair; decrypting, at the SC, the remaining encrypted information with its TK so as to obtain PK, based on which the SC can be registered.

In yet another aspect, the method can further include the step of generating separate random pairing-ids at the STB and the SC and share them with each other for future confirmation of whether they are paired with each other.

In an aspect, the method can further include the step of, upon receipt of the SC in the STB, enabling the SC and the STB to authenticate each other so as to establish a secure communication channel between them using a shared session key.

The present disclosure relates to the field of television signals delivered via broadcast networks. More particularly, present disclosure relates to a system and method for authenticating a set top box (STB) in a broadcast network wherein a One Time Password (OTP) sent via a registered smartphone of a user is used to authenticate the set top box by a service provider (operator) and deliver content accordingly to it.

In an aspect, the present disclosure discloses a Reverse OTP (One Time Password) method to enhance system security in an interoperable STB framework. Whereas in usual OTP authentication methods source sends out an OTP to a recipient to authenticate the recipient, in the present invention, the recipient (a smart card SC as described herein configured in a STB) generates a random OTP for the source (operator headend) to authenticate itself/associated STB. Hence, proposed invention can be said to be using a Reverse OTP method.

In another aspect, proposed invention can enable a user to use his/her registered smartphone (also referred to as mobile device or mobile phone or simply as phone) to communicate with an STB through a paired application (app), and the smartphone can receive the random OTP generated by the SC in the STB.

In yet another aspect, the random OTP can be sent by the registered smartphone to corresponding operator headend over mobile network, and the operator headend (also simply referred to as operator hereinafter) can use this OTP in its broadcast network for authorization of the STB and accordingly, delivery of content to the STB.

In an aspect, even if smart card security is compromised, and smart card of an authenticated STB is cloned, the proposed invention can still restrict provision of service to only the authenticated STB.

In another aspect, proposed invention can detect a compromised STB (for example one carrying a cloned smart card) by using a challenge response method between the STB and operator headend through the registered smartphone.

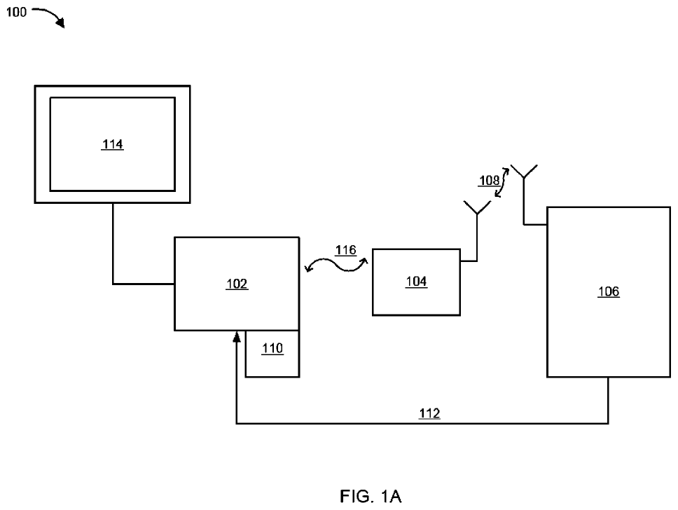

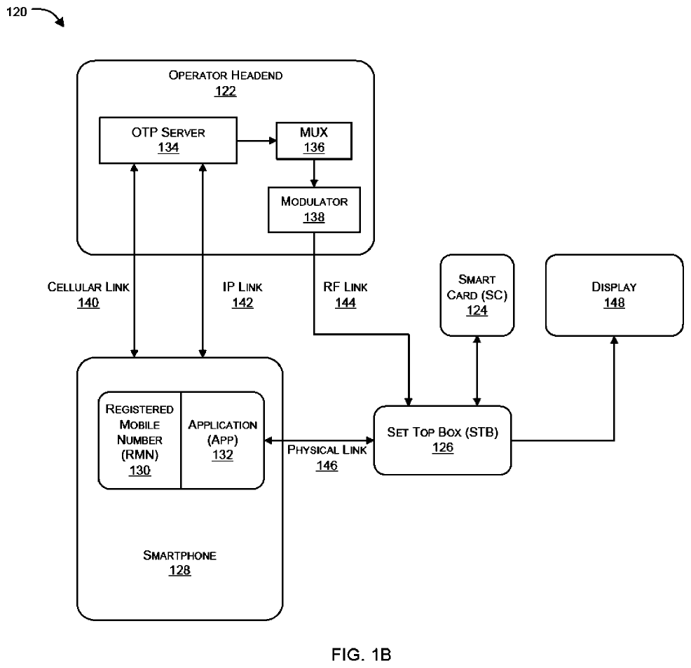

FIG. 1A illustrates an exemplary architecture of proposed invention, in accordance with an embodiment of the present disclosure.

In an aspect, an STB manufacturer having a key pair from root TA (Trusted Authority) can provide a Private/Public Key pair to an STB 102. Similarly, a smartphone 104 (or any other configured portable computing device such as a Tablet PC, a Laptop, a mobile device, or a wearable device) that is registered for an authorized user can obtain its own Private/Public Key pair from an operator (or any other configured third party) having the key pair from the same or a second root TA.

In another aspect, the proposed disclosure can include an application that can be downloaded/installed onto the smartphone 104, wherein using the Private/Public Key pair and the application (such as an app downloaded installed on the mobile/smart phone), STB 102 and smartphone 104 can perform handshake and authenticate each other. For the purpose the application/smartphone 104 can be operatively coupled with the STB 102 using any Personal Area Network (PAN) technology method shown as 116 such as near field communication (NFC), bluetooth or USB communication.

In yet another aspect, after such authentication, the smart card (SC) provided in STB 102 can generate a random OTP and the OTP can be sent to smartphone 104 using any Personal Area Network (PAN) technology method shown as 116 such as near field communication (NFC), bluetooth or USB communication.

In yet another aspect, upon receipt of the OTP, smartphone 104 can scramble it and send the scrambled OTP to operator headend 106 over mobile network 108. Alternatively, the OTP can be encrypted by the smart card (SC) that is configured in the STB 102 using the user key of the SC, and then sent to the operator through the smart phone 104. In another example, the encrypted OTP can be sent directly to the operator 106.

Upon receipt of the encrypted/scrambled OTP, operator headend 106 can be configured to decrypt/unscramble the OTP, and use said OTP value to scramble STB specific control messages and send such messages to STB 102. Smart card 110 can decrypt such messages and provide necessary information to STB 102 so that STB 102 can descramble TV signals being received and display them on the TV 114.

In another aspect, proposed invention can initiate a challenge response method between operator headend 106 and the STB if a security breach is suspected on STB 102.

FIG. 1B illustrates another exemplary architecture of the proposed invention in accordance with an exemplary embodiment of the present disclosure.

In an aspect, secure interoperable STB 126 being described herein may be operatively configured to receive a smart card (SC) 124 that is issued by an operator, which enables the STB to receive SC of any operator and then initiate a registration process to ensure compatibility between the STB and the SC and also capability of the STB to process messages/content received from the operation of the respective/fitted SC. STB 126 may be connected as required with a mobile device/smart phone 128 using a link 126, that may, in an aspect, be a physical link (such as a USB connection or any method suitable such as NFC communication to enable communication between the STB 126 and smartphone 128). An application/app 132 may be downloaded and installed on smartphone 128 so as to enable intended communication between the STB 126 and the operator 122 during registration of the SC that has been issued by the operator 122 to the user of the mobile phone 128. In an aspect, the smartphone 128 can have cellular connectivity enabled by normal cellular connection indicated as Registered Mobile Number (RMN) 130, wherein the RMN can be the mobile number of smartphone 128 that is registered for use with the STB 126 and/or with the operator 122, as elaborated further.

In another aspect, SC 124 of the present disclosure can be provided by an operator, said operator managing an operator headend shown as 122. Operator headend can have an OTP server 134 that is operatively connected to a MUX 136 and a modulator 138, the modulator 138 being configured to supply signals/channel data via an RF link 144 to STB 126. In an exemplary aspect, once the STB 126 has been properly verified/registered, the STB 126 can in turn supply unencrypted channel data to television display 148. For the purpose of this disclosure, terms operator headend 122 and operator can be used interchangeably. Also, it would be appreciated that the manner of communication including the protocols being used, technical standards being incorporated, type of data/content being transmission, and attributes related thereto are not limiting the scope of the invention in any manner, and all the representations and explanations there are exemplary and only for better appreciation of the claimed subject matter.

In an aspect, application 132 can communicate with OTP server 134 using an IP link 142 such as Internet, while RMN 130 (and so, smartphone 128) can communicate with the OTP server 134 using a cellular link 130. Any other suitable communication means can be similarly deployed and are completely a part of the present disclosure.

In an exemplary aspect, the proposed system can be deployed in two phases—a registration phase (that can include a registered mobile number (RMN) verification phase and an SC registration phase), and a runtime phase.

### RMN Verification Phase

During this phase, a subscriber/user can purchase a subscription from an operator that uses the proposed system. At this time, the operator can issue a smart card (SC 124) to the subscriber/user, said SC 124 being configured to support reverse OTP binding process described herein. The operator can also store, in its subscriber database, subscriber's/user's mobile number (hereinafter termed Registered Mobile Number or RMN) of the user's smartphone (interchangeably termed as mobile device herein, mobile device with the RMN being termed also as registered mobile device) along with other details pertinent such as smart card ID, user key, key authenticity certificate etc. The subscriber database can be stored at the OTP server 134. The database can also store the duration/period of subscription of each subscriber.

In another aspect, the user/subscriber can buy/get a set top box (STB 126) also configured to support the reverse OTP process described herein. Each STB can have its corresponding unique identification STB_ID (that can, for example, be hard coded in the STB's firmware during its manufacturing by the STB manufacturer itself). User can install an application (app 132) provided by the Operator of the proposed system in the smartphone/mobile device 128 configured for the Registered Mobile Number (RMN 130) such that during the registration process, when the subscriber starts the application 132 for the first time on his smartphone 128, the application 132 can generate a new RSA key pair, and obtain a certificate for the key pair issued by the operator. As known, RSA (Rivest-Shamir-Adleman) is a public-key cryptosystem widely used for data transmission wherein the encryption key is public and can be different from the decryption key which is kept secret (private), the two being termed as a key pair. Any other cryptosystem can easily be configured, and all such implementations/embodiments are well within the scope of the present invention.

In another aspect, the operator (via OTP server 134) and the application 132 can establish a secure communication channel by sharing a session key using their respective RSA key pairs. As known, a session key can be/incorporate an encryption and decryption key that is randomly generated to ensure the security of a communication session. In an aspect, once a secure communication channel has been established, the OTP server 134 (and through the OTP server, the operator) can then verify the subscriber's registered mobile number (RMN) using application 132 installed in the smartphone 128. For instance, the application can automatically retrieve the mobile number of the smartphone being used and send the mobile number to OTP server 134. OTP server 134 can check if the mobile number is one of the RMNs in its subscriber database and if so, get all information pertaining to the RMN such as corresponding smart card ID, user key, smart card's certificate, public key etc. Upon successful verification, an appropriate message can be sent to the mobile device. For instance, the message can be “Your RMN has been verified”. This verification of RMN can happen every time the subscriber wants to complete the registration.

### SC Registration Phase

During this phase, Smart Card SC 124 can be inserted into STB 126 (that can be any STB that the user has procured from open market, and not necessarily the one supplied by the Operator) and the STB 126 powered on. Thereafter, SC 124 and STB 126 can authenticate each other and consequently establish a secure communication channel between them using a shared session key. STB 126 can subsequently request for registration status from SC 124 such that if the registration process has been completed, STB 126 and SC 124 can pair with each other using pairing-ids stored at the time of registration. Once paired, STB 126 can decrypt, using SC 124, the encrypted data transmission that STB 126 is receiving from modulator 138 via RF link 144, and can send the decrypted data to display/television 148 of the subscriber/user, display 148 being operatively connected to STB 126.

However, if registration process is not complete yet, STB 126 can display an appropriate message on the user's TV/display 148 advising the user to complete the registration process at the earliest, as elaborated hereunder.

In an aspect, for the purpose of registration, the subscriber/user can connect his/her smartphone 128 (that carries the RMN as elaborated above) to the STB 126, based on which the STB 126 and the application 132 that is configured in the smartphone 128 can authenticate each other, and establish a secure communication channel using a shared session key. For the purpose the application 132/smartphone 128 can be operatively coupled with the STB 126 using any Personal Area Network (PAN) technology method shown as 116 such as near field communication (NFC), bluetooth or USB communication, or even through a wired communication if required. Thereafter, STB 126 can ask SC 124 to generate a random nonce (interchangeably termed as OTP herein). As known, a nonce is an arbitrary number that can only be used once. It is usually a random or pseudo-random number deployed very frequently in authentication protocols to ensure that old communications cannot be reused in replay attacks. SC 124 can generate the OTP, encrypt the same with its user key, and send the encrypted OTP to OTP server 134 (the operator) via STB 126 and the application 132. For the purpose, as seen in FIG. 1A, STB 126 and smartphone 128 can be physically linked so that the application 132 can communicate with STB 126. In another embodiment, the application 132/smartphone 128 can communicate with STB 126 through any Personal Area Network (PAN) technology (such as NFC, Bluetooth or USB) for which both the STB 126 and the smartphone 128 can be configured appropriately. All means of communication between the application 132/smartphone 128 and the STB 126 are completely within the scope of the present disclosure.

Further, the encrypted OTP can be sent to OTP server 134 using an IP Link 142 that can be setup between the application 132 and the OTP server 134. Alternatively, the application 132 can transfer the encrypted OTP to cellular portion of smartphone 128 (shown as RMN 130) and cellular link 140 can be used to transfer the encrypted OTP to OTP server 134, or any other alternate means can be similarly deployed. All means of communication between smartphone 128 and OTP server 134 are completely a part of the present disclosure.

In yet another aspect, OTP server 134 can decrypt the OTP received using the subscriber's user key. Thereafter, the server can form a temporary key (TK) using:
TK=f(OTP, user key)

In an aspect, the function f( ) can be a one way function. e.g. hash function with strong collision resistance. In this manner, uniqueness of different TKs is assured.

In another aspect, SC 124 can also form the same TK using same function as used by the OTP server (as SC generated the OTP and a public user key can be configured with SC 124/made accessible to SC 124 at anytime). In this manner, both OTP server 134 and SC 124 can have the same TK.

In yet another aspect, OTP server 134 can thereafter generate a random periodic key (PK) that can encrypt all subscribe-specific data that is to be used after the registration process is finished. Such data can include, for instance, channels subscribed by the user/subscriber, subscription period, appropriate codecs to encrypt/decrypt data being transmitted over various channels, and any other such data relevant.

In an embodiment, the PK can be configured to have a validity/duration same as that of registration sought by the user. Thereafter, the operator can renew the periodic key (PK) automatically if subscriber does not re-register before validity expires.

In another exemplary embodiment, in case the user renews his/her registration (that is, goes for a further validity period), the operator can generate a new periodic key for the new validity period and the operator can continue sending data to the user's STB. On the other hand, if the user does not renew his/her registration, the corresponding PK can expire and accordingly, the operator can stop sending data to the user's STB. Renewal of registration can require the user getting a new SC, or getting the existing SC itself overwritten by new data as elaborated above.

In another aspect, the PK as formed above can be encrypted along with other relevant information using the TK to generate an encrypted PK. The encrypted PK can again be encrypted using the STB's public key to generate aggregate encrypted information (AEI). Thereafter, the AEI can be sent by OTP server 134 to app 132 that can in turn send the AEI to STB 126. In another exemplary embodiment, OTP server 134 can send the AEI to STB 126 using RF link 144 enabled via MUX 136 and modulator 138.

In yet another aspect, upon receipt of the AEI, STB 126 can decrypt it with STB's private key to derive the decrypted AEI (but still encrypted using the TK). This decrypted AEI can be sent by STB 126 to SC 124. Using the temporary key (TK) that SC 124 also has, SC 124 can decrypt remaining information in the AEI and thereby get access to all subscriber-specific data that the periodic key (PK) has.

Since SC 124 now has all subscriber-specific data, data stream being received by STB 126 from operator headend 122 via RF link 144 can be appropriately processed. Decrypted data of channels that the user has subscribed to, for the period of subscription, can be sent to display 148 by SB 126 and the user/subscriber can watch such channels as usual.

In another aspect, SC 124 and STB 126 can generate separate random pairing-ids and share them with each other. These ids can be stored by them in their non-volatile memories and can be further used by them to identify each other as and when required.

In yet another aspect, SC 124 can also send registration data like paired STB_ID, pairing-ids etc to operator/OTP server 134 by encrypting it with its public key. The operator can use this information for some security checks and validation. Further, using such data SC 124 and STB 136 can be paired for future use.

In this manner, after security checks and validation as above, the operator/OTP server 134 can send registration success status to STB 126 smartphone 128/app 132. The status can accordingly be communicated to SC 124 by STB 126, as well as displayed on smartphone 128. As already elaborated, upon successful registration, SC 124 has information regarding the time period for which it can decrypt the encrypted transmission data being received by the STB (by using the PK as elaborated above). In this manner, SC 124 can be registered to work with STB 126 for the operator headed/operator that has provided SC 124 to the subscriber/user.

### Runtime Phase

After successful registration as elaborated above, whenever STB 126 powers up with SC 124 inserted in it, STB 124 and SC 126 can check if they are paired with each other and if so, SC 124 can use subscriber-specific data (PK) as already available with it to process the transmission data being received by STB 124, as elaborated above.

In another aspect, if STB 124 and SC 126 can not be paired with each other (for instance, when a non-registered SC is inserted into STB 126), STB 126 can ask the subscriber/user to complete the registration process as elaborated above,

If they are not paired with each other, STB 126 can display an appropriate message on the user's TV/display 148 advising the user to complete the registration process at the earliest, as elaborated above.

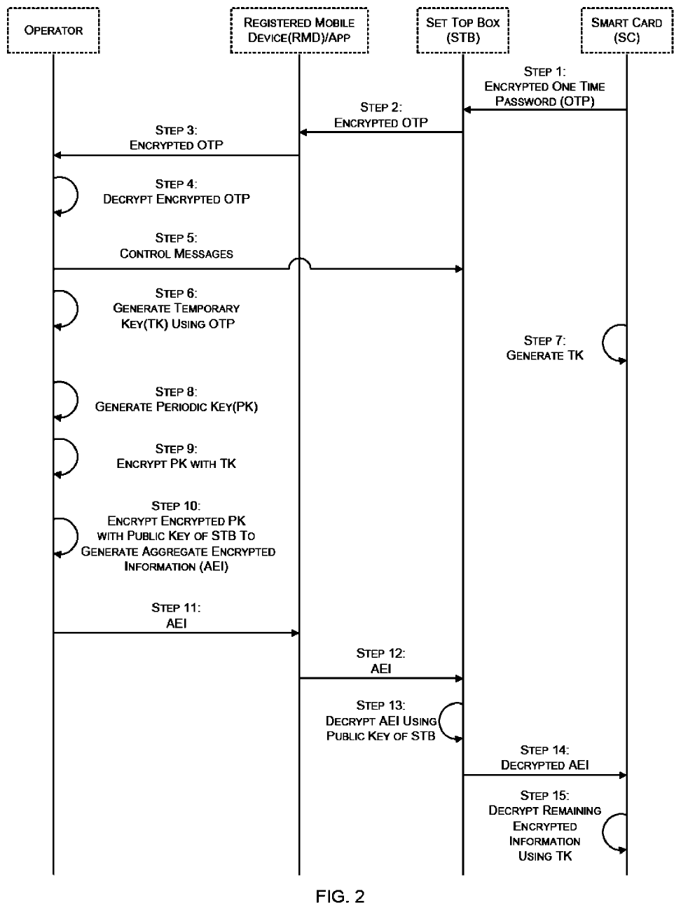

FIG. 2 elaborates via a sequence chart working of the proposed invention, in accordance with an exemplary embodiment of the present disclosure.

As illustrated, proposed system can enable a smart card (SC) provided by an operator to generate an encrypted one-time password (OTP). The smart card can be operatively configured/connected with a set top box (STB) and so, the STB can receive the encrypted OTP.

A registered mobile device (RMD, interchangeably termed as smartphone herein) of the user can be connected to the STB. The connection can be physical (for instance, a USB cable) or any other suitable communication method such as a Near Field Communication(NFC) method like Bluetooth. Using such means, the STB can send the encrypted OTP to the registered mobile device as shown at step 2.

The RMD can have a mobile application of the proposed system installed on itself. Using an IP link enabled by the app, the RMD can send the encrypted OTP to the operator, as shown at step 3. It can be readily understood that the operator can be, for instance, a server with a subscriber database that stores various subscriber data such as registered mobile number, user key and the like.

The operator can verify that the encrypted OTP is being sent from a mobile device whose registered mobile number exists in its subscriber database. Thereafter, by retrieving the user key from the database, the operator/server can decrypt the encrypted OTP as indicated at step 4 and accordingly send control messages to the STB, as illustrated at step 5.

Further, the operator can generate a temporary key (TK) using the OTP as illustrated at step 6. The same temporary key can also be generated by the smart card, as shown at step 7 (or the operator can send the TK to the STB that can then pass the TK to the SC).

Next, the operator can generate a random periodic key PK) as shown at step 8. The PK can be used to encrypt all subscriber-specific data. Such data can include, for instance, channels subscribed by the user/subscriber, subscription period, appropriate codecs to encrypt/decrypt data being transmitted over various channels, and any other such data relevant. The operator can send various channels data during the subscription period to the STB, and thereafter stop sending such data (or appropriate codecs) unless subscriber renews the subscription period.

At step 9, the operator can encrypt the PK with the TK, and at step 10, further encrypt the encrypted PK with public key of the STB to generate aggregate encrypted information (AEI). Thereafter, the operator can send the AEI to the smartphone as shown at step 11 and the smartphone can then provide the AEI to the STB. The AEI can be sent to the application configured in the smartphone using an IP Link.

Upon receipt of the AEI, the STB can decrypt the AEI using its private key as shown at step 13. Further, the STB can provide the decrypted AEI to the smart card (SC) it is operatively connected to, as shown at step 14.

Upon receipt of the decrypted AEI, the smart card can use the TK to decrypt the remaining encrypted information. In this manner the smart card can get all subscriber-specific data, for instance, channels subscribed by the user/subscriber, subscription period, appropriate codecs to receive and decode the data being transmitted over various channels, and any other such data. Using all such data the SC can decrypt various channel data being received by the STB and the STB can accordingly provide decrypted data to a receiver it can be connected to.

In this manner, proposed system can enable STB independence/interoperability since any STB need only be inserted with SC provided by an operator to enable receipt of various channels being transmitted by the operator as per subscription specific data of the subscriber/user who has obtained the SC. Only channels subscribed to by the user can be received by the user, thereby avoiding reception of unauthorized content.

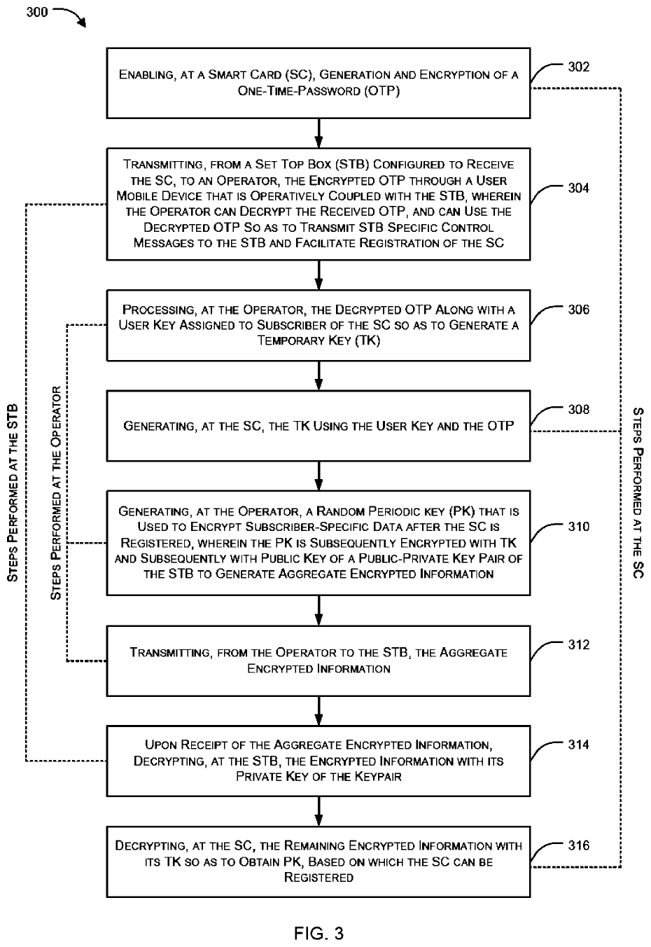

FIG. 3 illustrates a method of working of the proposed invention in accordance with an exemplary embodiment of the present disclosure.

In an aspect, present disclosure elaborates upon a method for authenticating a set top box (STB) in a broadcast network wherein a One Time Password (OTP) sent via a registered smartphone of a user is used to authenticate the set top box by a service provider (operator) and deliver content accordingly to it.

The method can include at step 302, enabling, at a smart card (SC) generation and encryption of a one-time-password (OTP)

The method can include, at step 304, transmitting, from a set top box (STB) configured to receive the SC, to an operator, the encrypted OTP through a user mobile device that is operatively coupled with the STB, wherein the operator can decrypt the received OTP, and can use the decrypted OTP so as to transmit STB specific control messages to the STB and facilitate registration of the SC.

The method can further include, at step 306, processing, at the operator, the decrypted OTP along with a user key assigned to subscriber of the SC so as to generate a temporary key (TK), and at step 308, generating, at the SC, the TK using the user key and the OTP.

The method can further include, at step 310, generating, at the operator, a random periodic key (PK) that is used to encrypt subscriber-specific data after the SC is registered, wherein the PK is subsequently encrypted with TK and subsequently with public key of a public-private key pair of the STB to generate aggregate encrypted information, and at step 312, transmitting, from the operator, to the STB, the aggregate encrypted information.

The method can further include, at step 314, upon receipt of the aggregate encrypted information, decrypting, at the STB, the encrypted information with its private key of the key pair, and at step 316 decrypting, at the SC, the remaining encrypted information with its TK so as to obtain PK, based on which the SC can be registered.

In another aspect, the method can also include initiating a challenge response method at operator headend if a security breach is suspected on STB.

In a non-limiting embodiment, a Private/Public Key management in an interoperable STB can be achieved in the following manner:
i. A TA(trusted authority) allocates separate Private/Public Key pair to each operator and STB manufacturer;
ii. STB manufacturers and operators act as secondary TA
iii. STB manufacturers allocate Private/Public Key pair to each STB it manufactures;
iv. Operators allocate Private/Public Key pair to each smart card it provides to the subscribed users;
v. Operators also allocate Private/Public Key pair to each smartphone of its registered users.

Although the proposed system has been elaborated as above to include all the main components, it is completely possible that actual implementations may include only a part of the proposed components or a combination of those or a division of those into sub-modules in various combinations across multiple devices that can be operatively coupled with each other, including in the cloud. Further the components can be configured in any sequence to achieve objectives elaborated. Also, it can be appreciated that proposed system can be configured in a computing device or across a plurality of computing devices operatively connected with each other, wherein the computing devices can be any of a computer, a laptop, a smartphone, an Internet enabled mobile device and the like. Therefore, all possible modifications, implementations and embodiments of where and how the proposed system is configured are well within the scope of the present invention.

As used herein, and unless the context dictates otherwise, the term “coupled to” is intended to include both direct coupling (in which two elements that are coupled to each other or in contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While some embodiments of the present disclosure have been illustrated and described, those are completely exemplary in nature. The disclosure is not limited to the embodiments as elaborated herein only and it would be apparent to those skilled in the art that numerous modifications besides those already described are possible without departing from the inventive concepts herein. All such modifications, changes, variations, substitutions, and equivalents are completely within the scope of the present disclosure. The inventive subject matter, therefore, is not to be restricted except in the spirit of the appended claims.

### Advantages of the Invention

The present disclosure provides for an interoperable set top box (STB) framework wherein an STB can be used with different operators thereby encouraging competition and technical innovation, and reducing e-waste.

The present disclosure provides for an STB that need not be discarded when its operator is changed.

The present disclosure provides for an STB that prevents any unauthorized reception of content in an interoperable STB framework.

We claim:

1. A set top box (STB) configured to receive an unregistered smart card (SC) that is issued by an operator, said STB being further configured to:
enable said unregistered SC to generate and encrypt a one-time-password (OTP); and
transmit said encrypted OTP to the operator through a user mobile device that is operatively coupled with said STB, wherein said operator decrypts said received OTP, and uses said decrypted OTP so as to transmit STB specific control messages to said STB and facilitate registration of said SC.

2. The STB as claimed in claim 1, wherein said SC is configured to store any or a combination of a unique SC ID, user key, SC certificate, and a public key part of public-private key pair, and wherein said SC encrypts said OTP using said user key.

3. The STB as claimed in claim 1, wherein said STB is bought from a manufacturer that is different from said operator, said STB being associated with a unique STB ID.

4. The STB as claimed in claim 1, wherein said user mobile device is configured with an application provided by the operator, said application being coupled with registered mobile number of said user mobile device.

5. The STB as claimed in claim 4, wherein said application generates a key pair and receives a certificate issued for said key pair from said operator, using which, a session is initiated between said operator and said application configured in said user mobile device.

6. The STB as claimed in claim 4, wherein said operator verifies subscriber corresponding to said user mobile device based on said registered mobile number.

7. The STB as claimed in claim 1, wherein upon receipt of said SC in said STB, said SC and said STB authenticate each other so as to establish a secure communication channel between them using a shared session key.

8. The STB as claimed in claim 1, wherein a second secure communication channel is established between said user mobile device and said STB using a second shared session key.

9. The STB as claimed in claim 1, wherein, at the operator, the decrypted OTP is processed along with a user key assigned to subscriber of said SC so as to generate a temporary Key (TK), which is also generated by the SC configured in the STB.

10. The STB as claimed in claim 9, wherein said operator is configured to generate a random periodic key (PK) that is used to encrypt subscriber-specific data after said SC is registered, wherein said PK is encrypted with TK and subsequently with public key of a public-private key pair of said STB, such that upon receipt of said encrypted information, the STB decrypts said encrypted information with its private key of the key pair, post which said SC decrypts the encrypted information with its TK so as to obtain PK, based on which said SC is registered.

11. The STB as claimed in claim 1, wherein said STB and said SC generate separate random pairing-ids and share them with each other for future confirmation of whether they are paired with each other.

12. A smart card (SC) issued by an operator and configured to be received in a set top box (STB), wherein said SC is initially unregistered and, as part of its registration process:
generates and encrypts a one-time-password (OTP); and
using said STB, transmits said encrypted OTP to the operator through a user mobile device that is operatively coupled with said STB, wherein said operator decrypts said received OTP, and uses said decrypted OTP so as to transmit STB specific control messages to said STB and facilitate registration of said SC.

13. The SC as claimed in claim 12, wherein said SC is configured to store any or a combination of a unique SC ID, user key, SC certificate, and a public key part of public-private key pair, and wherein said SC encrypts said OTP using said user key.

14. The SC as claimed in claim 12, wherein upon receipt of said SC in said STB, said SC and said STB authenticate each other so as to establish a secure communication channel between them using a shared session key.

15. The SC as claimed in claim 12, wherein, at the operator, the decrypted OTP is processed along with a user key assigned to subscriber of said SC so as to generate a temporary key (TK), which is also generated by the SC configured in the STB.

16. The SC as claimed in claim 14, wherein said operator is configured to generate a random periodic key (PK) that is used to encrypt subscriber-specific data after said SC is registered, wherein said PK is encrypted with TK and subsequently with public key of a public-private key pair of said STB, such that upon receipt of said encrypted information, the STB decrypts said encrypted information with its private key of the key pair, post which said SC decrypts the encrypted information with its TK so as to obtain PK, based on which said SC is registered.

17. The SC as claimed in claim 12, wherein said STB and said SC generate separate random pairing-ids and share them with each other for future confirmation of whether they are paired with each other.

18. A method of registering a smart card (SC) with a set top box (STB) configured to receive the SC, said method comprising the steps of:
enabling, at said SC, generation and encryption of a one-time-password (OTP); and
transmitting, from said STB, to said operator, said encrypted OTP through a user mobile device that is operatively coupled with said STB, wherein said operator decrypts said received OTP, and uses said decrypted OTP so as to transmit STB specific control messages to said STB and facilitate registration of said SC.

19. The method as claimed in claim 17, said method further comprising the steps of:
processing, at the operator, the decrypted OTP along with a user key assigned to subscriber of said SC so as to generate a temporary key (TK);
generating, at the SC, said TK using said user key and said OTP;
generating, at the operator, a random periodic key (PK) that is used to encrypt subscriber-specific data after said SC is registered, wherein said PK is subsequently encrypted with TK and subsequently with public key of a public-private key pair of said STB to generate aggregate encrypted information;
transmitting, from the operator, to the STB, said aggregate encrypted information;
upon receipt of said aggregate encrypted information, decrypting, at the STB, said encrypted information with its private key of the key pair; and
decrypting, at the SC, the remaining encrypted information with its TK so as to obtain PK, based on which said SC is registered.

20. The method as claimed in claim 17, further comprising the step of generating separate random pairing-ids at said STB and said SC and share them with each other for future confirmation of whether they are paired with each other.

21. The method as claimed in claim 17, further comprising the step of, upon receipt of said SC in said STB, enabling said SC and said STB to authenticate each other so as to establish a secure communication channel between them using a shared session key.
